(19) United States
(12) Patent Application Publication
(10) Pub. No.: US 2016/0061787 A1
(43) Pub. Date: Mar. 3, 2016

(54) AUTOMATED ANALYSIS SYSTEMS

(71) Applicant: THE GENERAL HOSPITAL CORPORATION, Boston, MA (US)

(72) Inventors: Neil Vasdev, Cambridge, MA (US); Thomas Lee Collier, Chester, NH (US)

(21) Appl. No.: 14/782,523

(22) PCT Filed: Apr. 7, 2014
(86) PCT No.: PCT/US14/33153

§ 371 Date: Oct. 5, 2015

Related U.S. Application Data
(60) Provisional application No. 61/809,684, filed on Apr. 8, 2013.

(51) Int. Cl. G01N 30/14; G01N 30/62

(52) U.S. Cl. CPC G01N 30/14; G01N 30/62; G01N 2030/027

(57) ABSTRACT

The disclosure relates to systems and methods for performing high performance liquid chromatography (HPLC) on a liquid sample. The methods include automatically, using a computer, controlling a liquid sample including a plurality of components to flow through a first flow path in a system for HPLC. Flowing through the first flow path includes flowing the liquid sample through a capture column. The capture column is capable of trapping at least some of the components of the liquid sample. The method includes automatically, using the computer, controlling a solvent to flow through a second flow path in the system for HPLC. Flowing through the second flow path includes flowing the solvent through the capture column to elute the trapped components from the capture column; flowing the solvent and eluted components through an analysis column capable of separating the eluted components; and flowing the separated components to a detector.

### CLAIM OF PRIORITY

This application claims the benefit of U.S. Provisional Patent Application Ser. No. 61/809,684, filed on Apr. 8, 2013. The entire contents of the foregoing are hereby incorporated by reference.

### FIELD OF THE INVENTION

The invention relates to automated analysis systems, such as automated systems for column switching high-performance liquid chromatography for metabolite analysis.

### BACKGROUND OF THE INVENTION

High-performance liquid chromatography (HPLC) is a chromatographic technique that can be used for separating a mixture of components in a sample for identification, analysis, or purification of the components. In column switching metabolite analysis, a sample, such as a sample of blood plasma, is loaded onto a capture column that traps the analyte. The analyte is then eluted from the capture column onto an analytical chromatography column for separation. While metabolite analysis is useful, it can be fraught with human error in the typical manually operated HPLC systems and methods.

### SUMMARY OF THE INVENTION

The invention is based, at least in part, on the discovery that the operation of a system for automated column switching metabolite analysis can be controlled by a computer system to significantly increase throughput and sample-to-sample consistency and to significantly decrease the occurrence of errors. A sample, e.g., a body fluid sample, such as a blood sample or a urine sample, is injected into the system for analysis. The computer system automatically controls the flow of the sample through a first flow path through the system, including through a capture column that traps components of the sample. The computer system automatically controls the flow of a solvent through a second flow path through the system to elute the trapped components from the capture column and to flow the eluted components onto an analysis column. The analysis column separates the components for downstream analysis by detectors, such as a radioactivity detector and/or other types of detectors controlled by the computer system. The flow rate, flow volume, and timing of the flow through each flow path can be controlled by the computer system to ensure consistency and reproducibility across samples and across systems.

In one example of an implementation, the system can be used for radiometabolite analysis. Whole blood is filtered, e.g., under computer control, to obtain plasma for analysis by the system. The presence and quality of radioactive metabolites in the plasma can be detected by a downstream radioactivity detector. The system is capable of rapid separation of plasma from whole blood and rapid, computer-controlled flow through the system. Thus, even radioactive metabolites with short half-lives can be detected by downstream detectors in the system.

In one general aspect, methods for performing high performance liquid chromatography (HPLC) on a liquid sample include automatically, using a computer, controlling a liquid sample including a plurality of components to flow through a first flow path in a system for HPLC. Flowing through the first flow path includes flowing the liquid sample through a capture column. The capture column is capable of trapping at least some of the components of the liquid sample. The methods include automatically, using the computer, controlling a solvent to flow through a second flow path in the system for HPLC. Flowing through the second flow path includes flowing the solvent through the capture column to elute at least some of the trapped components from the capture column; flowing the solvent and eluted components through an analysis column capable of separating at least some of the eluted components; and flowing the separated components to a detector capable of detecting a property of the separated components.

Various embodiments of the methods can include one or more of the following features.

Automatically controlling the liquid to flow through the first flow path can include controlling the liquid to flow from an injection port, through a valve configured in a first configuration, and through the capture column. Automatically controlling the liquid to flow through the first flow path can include actuating the valve to the first configuration based on a signal from the computer. Automatically controlling the solvent to flow through the second flow path can include controlling the solvent to flow through the capture column, through the valve configured in a second configuration, and through the analysis column. Automatically controlling the solvent to flow through the second flow path can include actuating the valve to the second configuration based on a signal from the computer.

Automatically controlling the liquid to flow through the first flow path can include controlling a first pump to provide a flow of liquid. Controlling the first pump can include controlling the first pump based on a signal from the computer. Controlling the first pump can include controlling at least one of a flow rate, a flow duration, and a flow volume of the liquid.

Automatically controlling the solvent to flow through the second flow path can include controlling a second pump to provide a flow of solvent. Controlling the second pump includes controlling the second pump based on a signal from the computer. Controlling the second pump includes controlling at least one of a flow rate, a flow duration, and a flow volume of the solvent. The method can include receiving a signal from the second pump indicative of a fluid pressure in the second flow path. The method can include, if the fluid pressure is greater than a threshold pressure, controlling the solvent to flow through a third flow path in the system. Flowing through the second flow path can include flowing through the analysis column in a first direction and flowing through the third flow path can include flowing through the analysis column in a second direction opposite to the first direction. Controlling the solvent to flow through the third flow path can include actuating a reversing valve based on a signal from the computer.

Flowing through the first flow path can include flowing through the capture column in a first direction and flowing through the second flow path can include flowing through the capture column in a second direction opposite to the first direction.

The methods can include receiving a blood sample; and filtering the blood sample to separate plasma, wherein the liquid is the plasma. Filtering the blood sample can include filtering the blood sample through a membrane. Filtering the blood sample can include automatically controlling the filtering of the blood sample using the computer.

In some implementations, the detector can be configured to detect a radioactivity of the separated components. The methods can include fractionating the separated components. The liquids can include blood plasma.

In another general aspect, systems for high performance liquid chromatography (HPLC) include an injection port for receiving a liquid sample including a plurality of components; a capture column capable of trapping at least some of the components of the liquid sample; an analysis column capable of separating at least some of the components of the liquid sample; a detector for detecting a property of the components; and a computer. The computer is configured to automatically control the liquid sample to flow through a first flow path in the system. Flowing through the first flow path includes flowing the liquid sample through the capture column. At least some of the components of the liquid sample are trapped by the capture column. The computer is configured to automatically control a solvent to flow through a second flow path in the system. Flowing through the second flow path includes flowing the solvent through the capture column to elute at least some of the trapped components from the capture column, flowing the solvent and eluted components through the analysis column, and flowing the components separated by the analysis column to the detector.

Various embodiments of the new systems for HPLC can include one or more of the following features.

The systems can include a valve. The computer can be configured to actuate the valve to a first configuration to control the liquid to flow through the first flow path and to actuate the valve to a second configuration to control the liquid to flow through the second flow path.

The systems can include a first pump. The computer can be configured to control the first pump to provide a flow of liquid through the first flow path.

The systems can include a second pump. The computer can be configured to control the second pump to provide a flow of the solvent through the second flow path. The second pump can be configured to provide a signal to the computer indicative of a fluid pressure in the second flow path. The computer can be configured to, if the fluid pressure is greater than a threshold pressure, automatically control the solvent to flow through a third flow path in the system. Flowing through the second flow path cam include flowing through the analysis column in a first direction and flowing through the third flow path can include flowing through the analysis column in a second direction opposite to the first direction. The computer can be configured to actuate a reversing valve to control the solvent to flow through the third flow path.

The systems can include a filter device capable of separating plasma from a blood sample, and wherein the liquid is the plasma. The filter device can include a membrane. The computer can be configured to control the filter device.

The detector can include a radioactivity detector. The systems can include a fraction collector configured to fractionate the components separated by the analysis column.

In another general aspect, computer-readable storage media store instructions for causing a computer system to control a liquid including a plurality of components to flow through a first flow path in a system for HPLC. Flowing through the first flow path includes flowing through a capture column. The capture column is capable of trapping at least some of the components of the liquid. The instructions cause the computer system to control a solvent to flow through a second flow path in the system for HPLC. Flowing through the second flow path includes flowing through the capture column to elute at least some of the trapped components from the capture column; flowing through an analysis column capable of separating at least some of the eluted components; and flowing the separated components to a detector capable of detecting a property of the separated components.

Various embodiments of the computer-readable storage media can include one or more of the following features.

Controlling the liquid to flow through the first flow path can include controlling the liquid to flow from an injection port, through a valve configured in a first configuration, and through the capture column. The computer readable storage media can store instructions for actuating the valve to the first configuration. Controlling the solvent to flow through the second flow path can include controlling the solvent to flow through the capture column, through the valve configured in a second configuration, and through the analysis column. The computer readable storage medium can store instructions for actuating the valve to the second configuration.

Controlling the liquid to flow through the first flow path can include controlling a first pump to provide a flow of liquid. Controlling the first pump can include controlling at least one of a flow rate, a flow duration, and a flow volume of the liquid. At least one of the flow rate, the flow duration, and the flow volume can be specified by a user via a user interface.

Controlling the solvent to flow through the second flow path can include controlling a second pump to provide a flow of solvent. Controlling the second pump can include controlling at least one of a flow rate, a flow duration, and a flow volume of the solvent. At least one of the flow rate, the flow duration, and the flow volume can be specified by a user via a user interface.

The computer readable storage media can store instructions for causing the computer system to receive a signal from the second pump indicative of a fluid pressure in the second flow path; and if the fluid pressure is greater than a threshold pressure, controlling the solvent to flow through a third flow path in the system. Flowing through the second flow path can include flowing through the analysis column in a first direction and flowing through the third flow path can include flowing through the analysis column in a second direction opposite to the first direction. The computer readable storage medium can store instructions for causing the computer system to actuate a reversing valve to control the solvent to flow through the third flow path.

The computer readable storage media can store instructions for causing the computer system to control the operation of a filter capable of filtering a blood sample to separate plasma, wherein the liquid is the plasma. The computer readable storage media can store instructions for causing the computer system to control operation of the detector. The computer readable storage media can store instructions for causing the computer system to control operation of a fraction separator configured to fractionate the components separated by the analysis column.

The automated analysis systems described herein has a number of advantages. For instance, human intervention in the preparation and analysis of a sample is reduced or eliminated, thus reducing the possibility for human error. Furthermore, computer control over the operation of the automated analysis system helps to maintain consistency and reproducibility across processing of different samples within a single automated analysis system or even across multiple analysis systems. Such consistency and reproducibility can be important, e.g., for large-scale drug development studies. In addition, the automated analysis systems are capable of rapid filtration and processing of whole blood samples. Thus, for instance, in radiometabolite analysis applications using a radioactive tracer with a short half-life, the systems can filter and process a blood sample before the radioactive tracer has significantly decayed. In addition, the components of the automated analysis systems are integrated as a single unit, thus simplifying set-up and use of the systems and eliminating the need for an operator to build and maintain a home-made system.

Unless otherwise defined, all technical and scientific terms used herein have the same meaning as commonly understood by one of ordinary skill in the art to which this invention belongs. Although methods and materials similar or equivalent to those described herein can be used in the practice or testing of the present invention, suitable methods and materials are described below. All publications, patent applications, patents, and other references mentioned herein are incorporated by reference in their entirety. In case of conflict, the present specification, including definitions, will control. In addition, the materials, methods, and examples are illustrative only and not intended to be limiting.

Other features and advantages of the invention will be apparent from the following detailed description, and from the claims.

### BRIEF DESCRIPTION OF THE DRAWINGS

FIG. 1 is a diagram of a system for automated column-switching metabolite analysis described herein.

FIG. 2 is a flow chart of a process for using the system of FIG. 1.

FIG. 3 is a diagram of an injection flow path in the system for automated column-switching metabolite analysis shown in FIG. 1.

FIG. 4 is a diagram of a first flow path in the system for automated column-switching metabolite analysis shown in FIG. 1.

FIG. 5 is a diagram of a second flow path in the system for automated column-switching metabolite analysis shown in FIG. 1.

FIG. 6 is a diagram of a reverse flow path in the system for automated column-switching metabolite analysis shown in FIG. 1.

FIG. 7 is a diagram of an alternative system for automated column-switching metabolite analysis.

FIG. 8 is a flow chart of a sample preparation process.

FIG. 9A is a diagram of a membrane for filtration of a whole blood sample.

FIG. 9B is a diagram of a membrane filtration device using the membrane of FIG. 9A.

FIG. 10 is a block diagram of a computer system that can be used with the automated column-switching metabolite analysis systems described herein.

FIG. 11 is a diagram of a user interface for a computer system that controls the operation of the system for automated column-switching metabolite analysis.

FIG. 12 is a diagram of a computer system that can be used with the automated column-switching metabolite analysis systems described herein.

### DETAILED DESCRIPTION

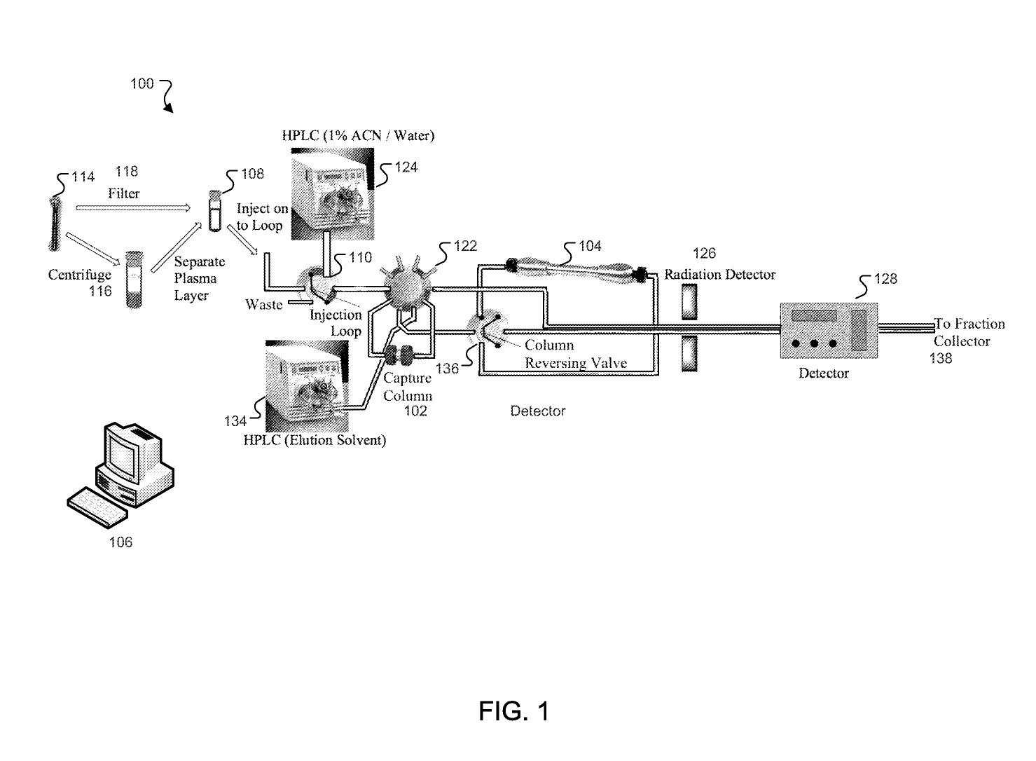

FIG. 1 shows one implementation of a system 100 for automated column switching metabolite analysis that is controlled by a computer system 106. A sample, such as a body fluid sample, e.g., a blood sample or a urine sample, is injected into the system for analysis. The computer system 106 automatically controls the flow of the sample through a first flow path through the system 100, including through a capture column 102 that traps components of the sample. The computer system 106 automatically controls the flow of a solvent through a second flow path through the system 100 to elute the trapped components from the capture column and to flow the eluted components onto an analysis column 104. The analysis column 104 separates the components for downstream analysis by detectors, such as a radioactivity detector and/or other types of detectors, controlled by the computer system 106. The flow rate, flow volume, and timing across each column can be controlled by the computer system 106 to ensure consistency and reproducibility across samples and across systems 100.

In one implementation, the system 100 can be used for radiometabolite analysis. Whole blood is filtered, e.g., under computer control, to obtain plasma for analysis by the system 100. The presence and quality of radioactive metabolites in the plasma can be detected by a downstream radioactivity detector. The system 100 is capable of rapid separation of plasma from whole blood and rapid, computer-controlled flow through the system 100. Thus, even radioactive metabolites with short half-lives can be detected by downstream detectors in the system 100.

### Operation of a System for Automated Column Switching HPLC

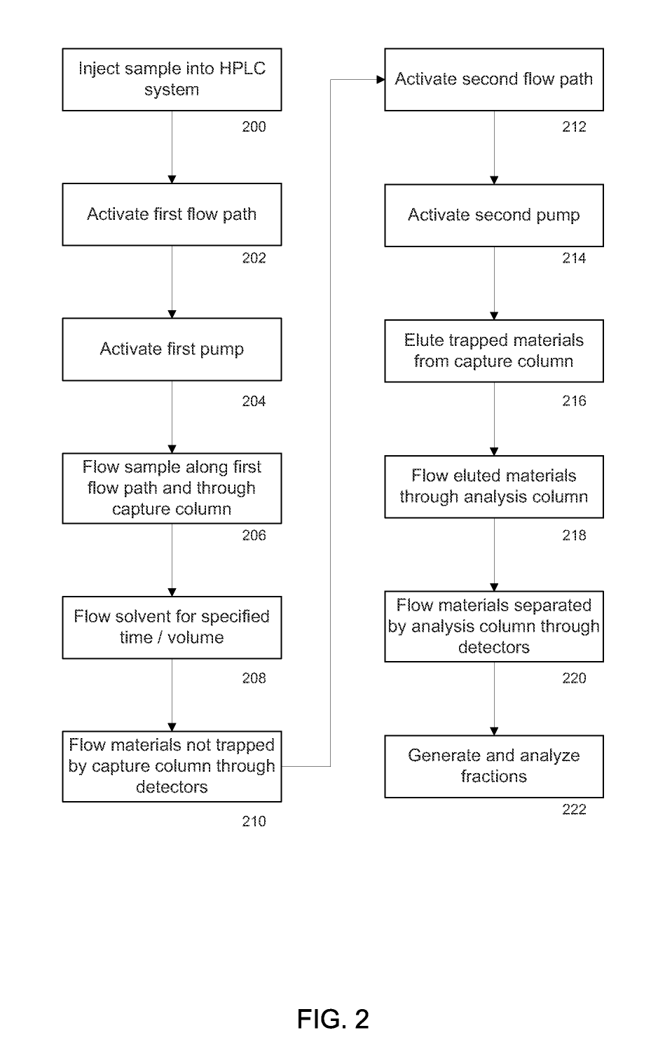

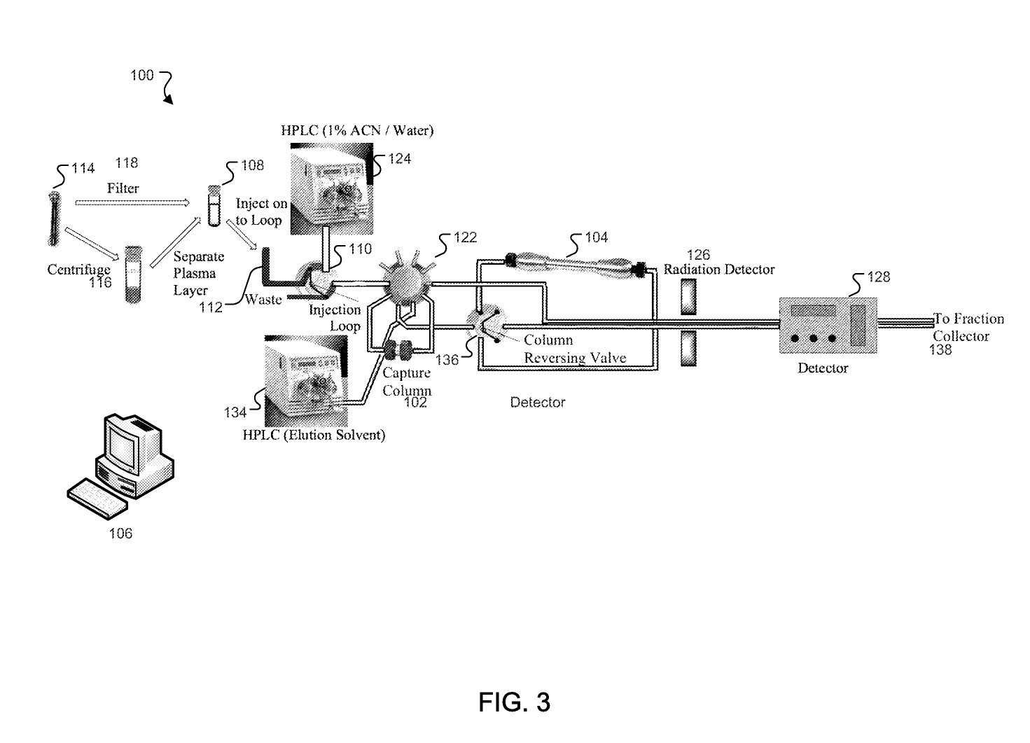

Referring to FIGS. 2 and 3, a prepared liquid sample 108 is injected into an injection loop 110 of the system 100 (200). A flow path 112 for the injection of a sample is indicated by the filled in flow pipes (FIG. 3). The sample 108 can be injected automatically, e.g., via computer-controlled injection, or manually by an operator of the system 100. Any waste products such as salts, unretained material, or other waste products, can be removed from the injection loop 110 via an outlet port 111.

The sample can be, e.g., blood plasma, urine, or another liquid sample, such as tissue extracts. For instance, a blood sample 114 can be prepared, e.g., by centrifugation 116, filtration 118, or another preparation technique, to obtain plasma for the prepared liquid sample 108. This sample preparation can be conducted automatically by the system 100 (discussed in greater detail below) or can be conducted manually by an operator of the system 100.

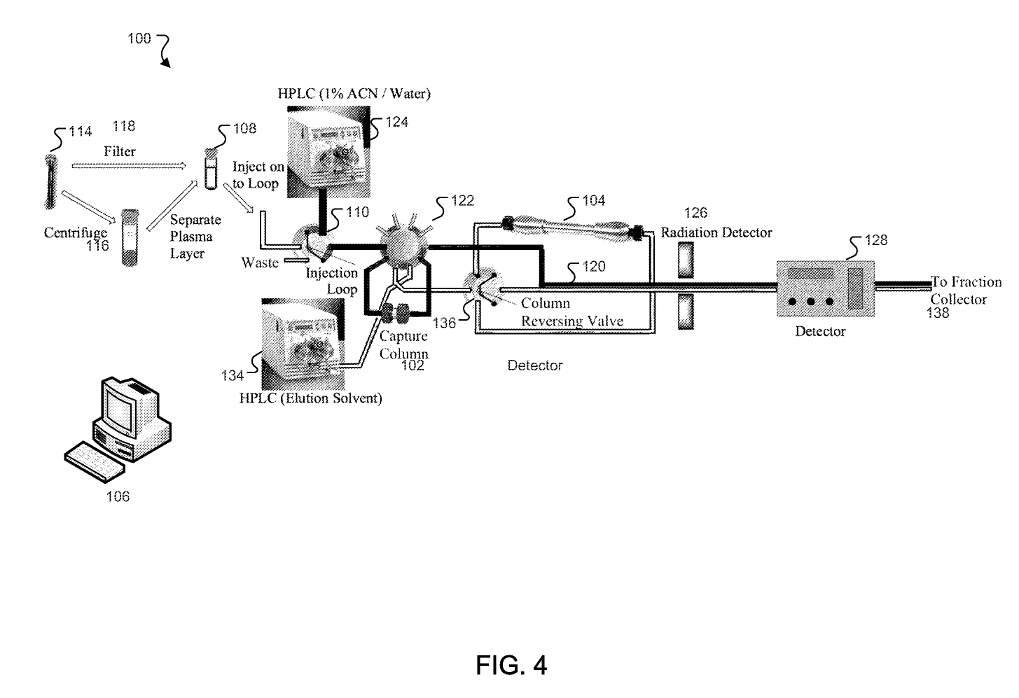

Referring to FIGS. 2 and 4, under the control of the computer system 106, a first flow path 120 is activated (indicated by the filled in flow pipes in FIG. 4) by actuating a valve 122 to a first position (202). For instance, the computer system 106 can provide a signal to the valve 122 to cause the valve to move to the first position. The valve 122 can be, e.g., an electrically or pneumatically actuated valve, such as a 10-port, 2-position valve.

The computer system 106 also activates a first pump 124 (204), such as an HPLC pump or another type of pump, to provide a flow of solvent along the first flow path 120. In one example, the first pump 124 provides a flow of 1% acetonitrile in water. The computer system 106 can control the first pump 124 to provide a flow of solvent at a specified flow rate, for a specified period of time, and/or for a specified volume of solvent. For instance, the first pump 124 can be controlled to provide a flow rate of about 0-10 mL/min. In one specific example, the pump 124 can be controlled to provide a flow rate of between 1-2 mL/min and to provide 6-12 mL of solvent flow.

The solvent flow passes through the injection loop 110 and carries the injected sample 108 through the valve 122 and through the capture column 102 (206). The capture column 102 can be a self-packed column or a commercial column and is capable of trapping at least some of the components of the injected sample 108 within the column 102. For instance, if the injected sample 108 is blood plasma, the capture column can be capable of trapping metabolites from the proteins in the plasma.

The computer system 106 controls the first pump 124 to provide solvent flow for a specified period of time and/or to provide a specified volume of solvent to wash the capture column (208), thus removing materials not trapped within the capture column 102 from the capture column 102. The solvent flow carries those materials not trapped within the capture column along the first flow path 120 through the valve 122 to one or more detectors 126, 128 for analysis of the materials not trapped within the capture column 102 (210). In some examples, e.g., for radiometabolite analysis applications, the detector 126 can be a radiation detector 114. In some examples, one or both of the detectors 126, 128 can be a detector such as an ultraviolet detector, a visible detector, a fluorescence detector, a light scattering detector, a refractive index detector, a mass spectrometer, a conductivity detector, an amperometric detector, a pulsed amperometric detector, an atomic absorption detector, an enzymatic detector, a pH detector, a selective electrode detector, or another type of detector capable of on-line detection.

In one example, the capture column 102 can be an Oasis® HLB 6 cc column (Waters Corporation, Milford, Mass.).

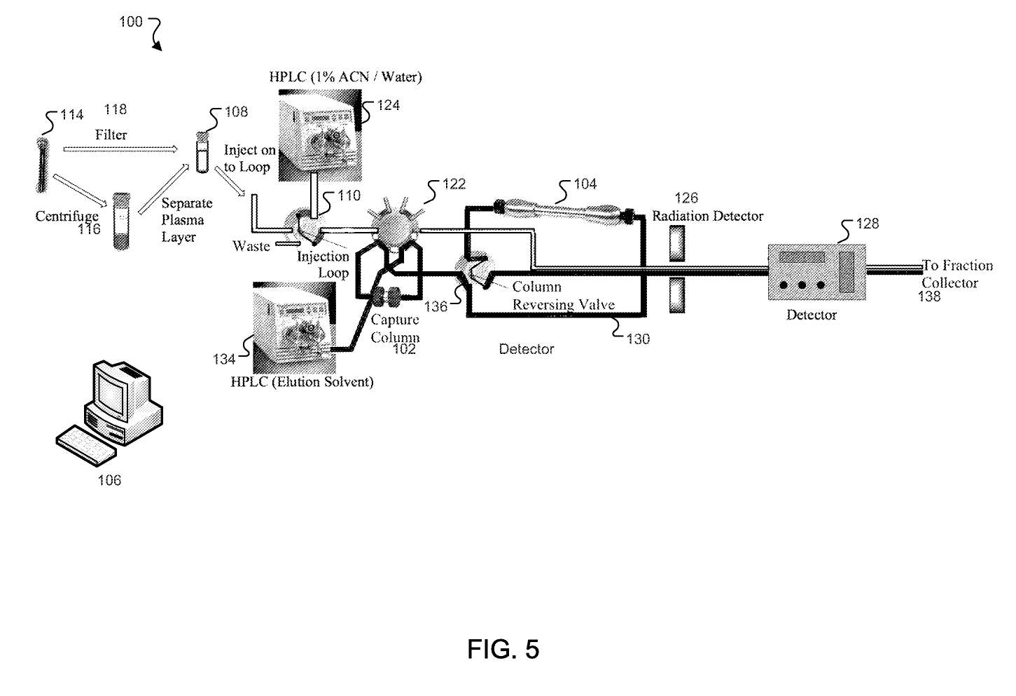

Referring to FIGS. 2 and 5, after the first flow path has been active for the specified volume or time of solvent flow, the pump 124 is turned off. Under the control of the computer system 106, a second flow path 130 is activated (indicated by the filled in flow pipes in FIG. 5) by actuating the valve 122 to a second position (212). For instance, the computer system 106 can provide a signal to the valve 122 to cause the valve to move to the second position.

The computer system 106 also activates a second pump 134 (214), such as an HPLC pump or another type of pump, to provide a flow of solvent along the second flow path 130. In one example, the second pump 134 provides a flow of an elution solvent, e.g., 50% acetonitrile/water, 65% Methanol/0.1 M ammonium formate, or 40% acetonitrile/0.1% acetic acid. The computer system 106 can control the second pump 134 to provide a flow of solvent at a specified flow rate, for a specified period of time, and/or for a specified volume of solvent. For instance, the second pump 134 can be controlled to provide a flow rate of about 0-10 mL/min. In one specific example, the second pump 134 can be controlled to provide a flow rate of between 2 mL/min and to provide 20 mL of solvent flow.

The solvent flow from the second pump 134 passes through the valve 122 and through the capture column 102. The direction of solvent flow through the capture column 102 in the second flow path 130 is opposite to the direction of solvent flow through the capture column 102 in the first flow path 120. This reversal enables the solvent flowing through the second flow path 130 to elute the trapped materials off of the capture column 102 (216). The solvent carries the eluted materials through the valve 122, through a reversing valve 136 (discussed in more detail below), and through the analysis column 104 (218). The analysis column 104 is a chromatography column that is capable of separating the eluted materials carried by the solvent, such as a C-18 column.

Further solvent flow from the second pump 134 along the second flow path 130 elutes the separated materials off of the analysis column 104 and carries those materials through the detectors 126, 128 (220) for analysis. In some examples, the radioactivity detector 126 can be a coincidence gamma detector (e.g., from Bioscan, Inc., Washington, D.C.).

Fractions corresponding to each separated material can be collected by a fraction collector 138. The fraction collector 138 is capable of automatic, computer-controlled collection of sample fractions of a specified volume and/or collection of sample fractions at specified times. In one example, one fraction can be collected for each minute of solvent flow. In one example, the collection of a new fraction can be triggered by a change in a sample property (e.g., a radioactivity, a fluorescence, or another property) detected by one or more of the detectors 126, 128.

The fractions can be further analyzed off-line (222). For instance, if the radiation detector 126 does not detect any radioactive metabolite in a sample (which may be due, e.g., to low activity due to decay of the radioactive metabolite or to biological removal of the radioactive metabolite from the sample), the fractions of that sample can be analyzed using a more sensitive well counter to count the radioactivity in each fraction. The fractions can also be analyzed using other detectors and analysis systems that are incompatible with on-line use.

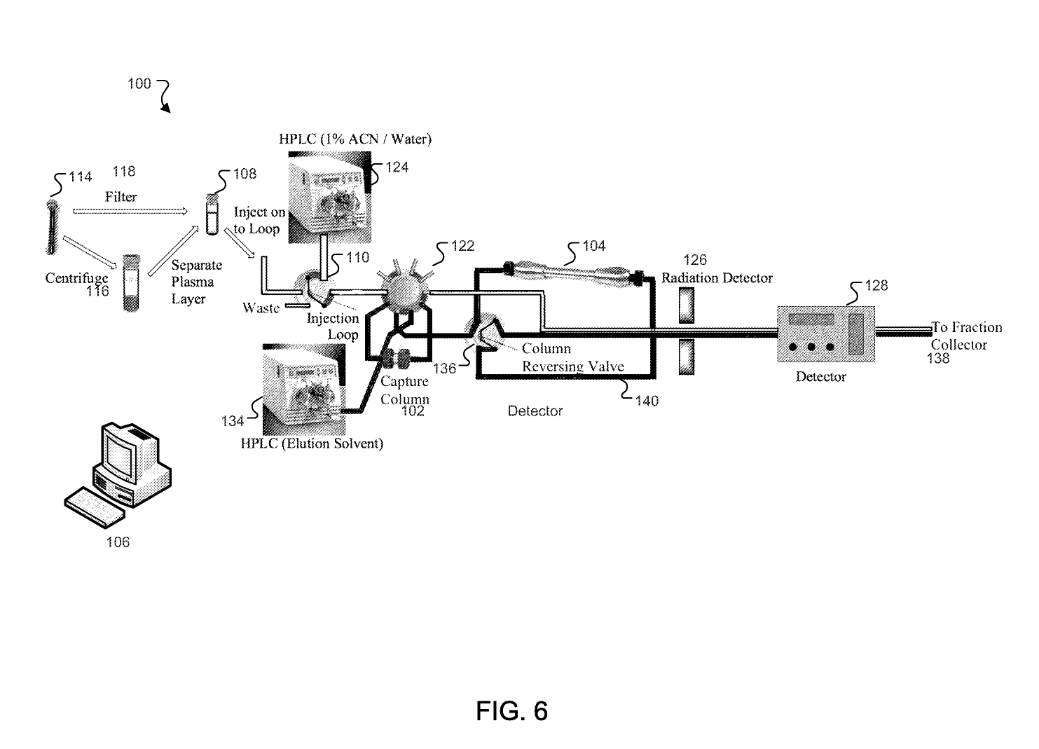

Referring to FIG. 6, in some examples, one or both of the pumps 124, 134 are capable of detecting the fluid pressure along the respective flow paths and communicating the detected fluid pressure to the computer system 106. The pressure in a flow path can become high if one of the columns 102, 104 along the flow path becomes clogged with material. If the pressure in a flow path exceeds a threshold value (e.g., about 3000 psi or about 200 Bar), the computer system 106 can activate a third flow path 140 by actuating the reversing valve 136. The reversing valve 136, which can be, e.g., a six-port, two-position valve, allows solvent to flow from the second pump 134 through the capture column 102 in the reverse direction (i.e., in the direction of the second flow path) and through the analysis column 104 in the reverse direction (i.e., opposite to the direction of the second flow path). This reverse flow can sweep any materials that are clogging the capture column 102 and/or the analysis column 104. The computer can control the reversing valve 136 to activate the third flow path 140 for a specified amount of time or a specified flow volume, e.g., a sufficient time or volume to substantially completely clear the capture column 102 and the analysis column 104.

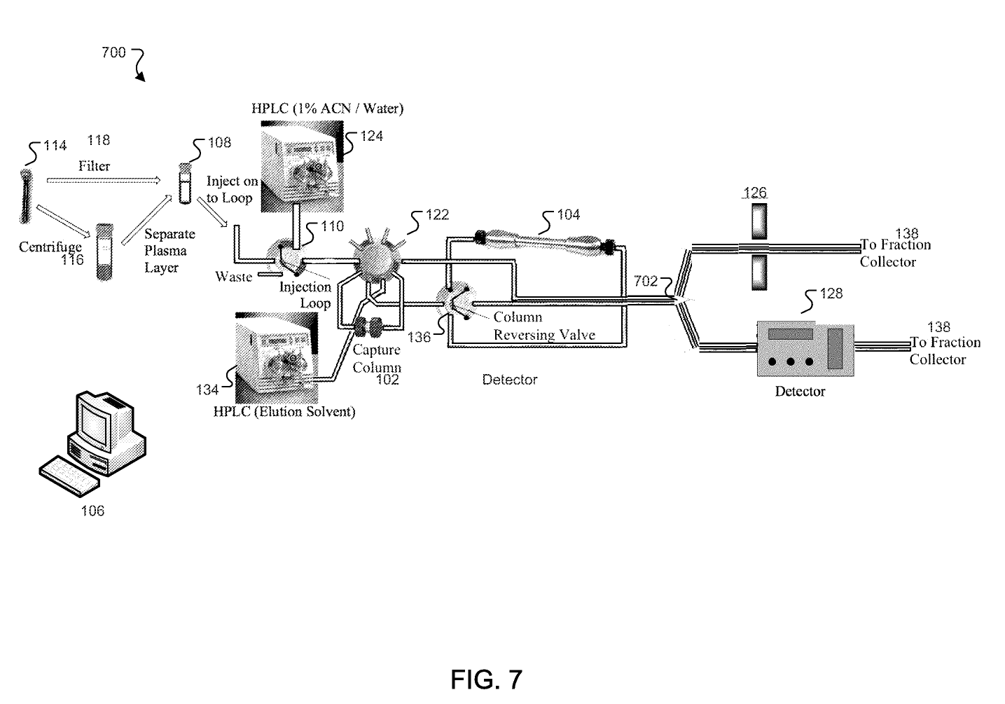

In the example system 100 depicted in FIGS. 3-6, the detectors 126, 128 are arranged in series along the flow path. Referring to FIG. 7, in another example system 700, a split valve 702 can provide fluid flow to two or more detectors 126, 128 arranged in parallel. For instance, a parallel arrangement can be used to connect the radiation detector 126 in parallel with a mass spectrometer 128.

In some example systems, the radiation detector 126 is not used. One or more other detectors 128 can be used to analyze the materials processed by the system. For instance, the radiation detector 126 cannot be used if the materials under analysis do not include an isotopically labeled component.

The system 100 can be provided as an integrated unit, e.g., with the components fixed on a base, e.g., enclosed in a housing, or otherwise integrated. In some examples, the computer system 106 is integrated with the system 100; in some examples, the computer system 106 is a separate computer system that communicates with the system 100.

### Sample Preparation for the System for Automated Column Switching HPLC

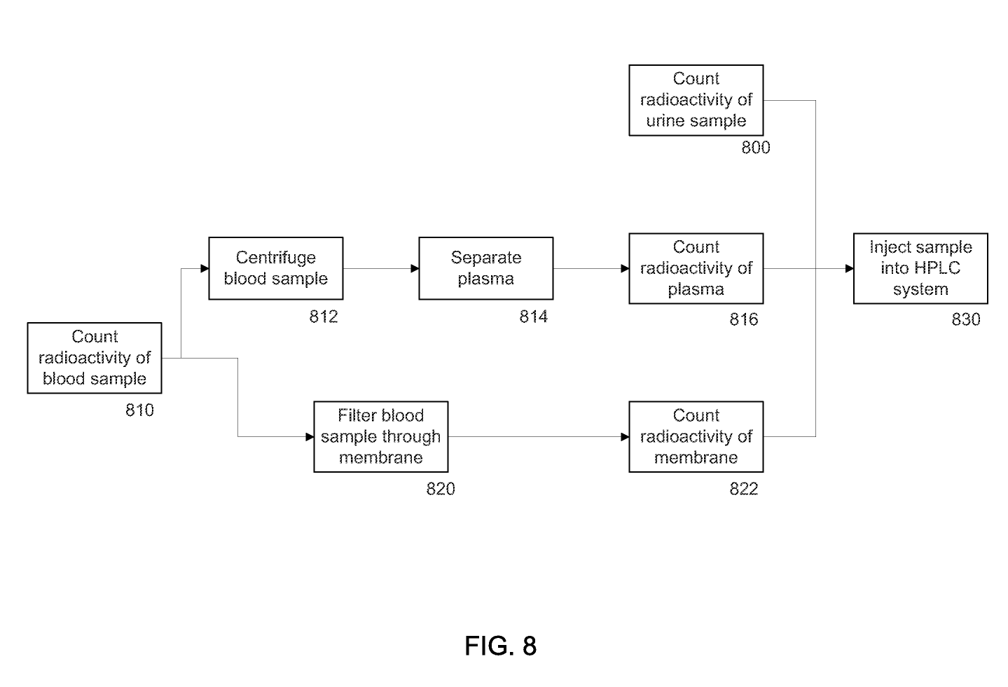

Referring to FIG. 8, samples can be prepared for injection into the system for automated column switching HPLC (referred to herein as the “system”) by a variety of methods.

For instance, the radioactivity of a collected urine sample can be counted (800) and the urine sample can be directly injected into the system (830), e.g., manually by an operator of the system or automatically under control of the computer system 106 or another computer system.

Preparation of a blood sample can, in certain examples, involve processing the blood sample to isolate the plasma. In one example, the radioactivity of a collected blood sample can be counted (810). The blood sample can be centrifuged (812), e.g., manually or under control of the computer system 106 or another computer system. The plasma in the centrifuged blood sample is separated from other components of the blood (814), such as buffy coat and whole cells, and the radioactivity of the plasma is counted (816). The plasma can then be injected into the system (830), e.g., manually by an operator of the system or automatically under control of the computer system 106 or another computer system.

In another example, a blood sample can be filtered through a membrane (820) to separate the plasma from other components of the blood. For instance, a membrane that is capable of capturing cellular components of blood, such as red blood cells, white blood cells, and platelets, while allowing the plasma to pass through the membrane. The radioactivity of the membrane is counted (822) and the plasma can injected into the system (830), e.g., manually by an operator of the system or automatically under control of the computer system 106 or another computer system.

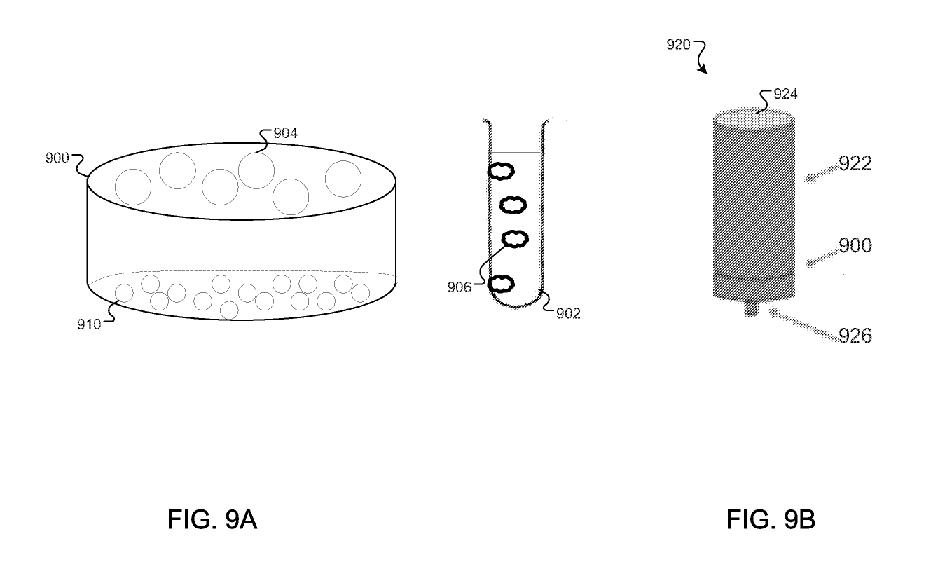

Referring to FIG. 9A, an example membrane 900 for separating plasma from other components of a blood sample 902 can be a highly asymmetric membrane that captures cellular components 906 of blood, such as red blood cells, white blood cells, and platelets, in large pores 904 of the membrane without lysis. Plasma 908 flows through the large pores 904 and into smaller pores 910 on a downstream side of the membrane. An example of such a membrane is a Pall Vivid™ membrane (Pall Corporation, Port Washington, N.Y.), which is formed of a cross section of a pillar chip made by 10× Technology LLC and has pillars which are 14 μm tall and have a base dimension of 151 μm.

This type of membrane can enable rapid separation (e.g., typically within less than about two minutes for a volume of 1 mL of whole blood and slightly longer for up to 5 mL of whole blood and can yield plasma similar in HPLC and SDS-PAGE (sodium dodecyl sulfate polyacrylamide gel electrophoresis) profiles to centrifuged plasma samples. Furthermore, non-specific binding of clinically relevant biomarkers, such as proteins, does not occur when blood containing those biomarkers is filtered by the membrane. For instance, whole blood filtered by the Pall Vivid™ membrane and whole blood separated by centrifugation show equivalent two-dimensional gel electrophoresis protein profiles for the cardiac biomarker Troponin I, indicating that there is no significant reduction in protein concentration by the membrane.

Referring to FIG. 9B, a holder 920 can contain the membrane 900 to facilitate the separation of plasma from other components of a blood sample. The membrane 900 is attached to a tube 922 into which a whole blood sample can be deposited. The tube can be formed of a non-reactive, biologically inert material, such as PEEK (Polyether ether ketone), HDPE (High-density polyethylene), or Teflon® (PTFE, Polytetrafluoroethylene). In some examples, the membrane 900 can be removably attached to the tube 922 via a threaded connection, a snap-fit connection, or another type of removable connection. In some examples, the membrane 900 can be formed integrally with the tube 922. A top side 924 of the tube 922 can be open in order to reduce or eliminate the formation of an airlock preventing filtration from occurring. The downstream side of the membrane 900 feeds into a connection, such as a Luer connection 926, which can be connected to a sample holder, an injection syringe, or another destination for the separated plasma. Filtration occurs by gravity with no vacuum or pressure being applied to the whole blood sample in the tube 922 or to the downstream side of the membrane 900. The holder 920 and membrane 900 can filter a range of blood volumes, e.g., as little as about 50-100 μL to as much as about 5 mL of blood.

Blood filtration through the membrane 900, e.g., using the holder 920, can be performed under computer control, e.g., under the control of the computer system 106. For instance, the holder 920 and membrane 900 can be a component of the system 100. That is, a whole blood sample can be provided to the system 100, and the system 100 can automatically (under control of the computer system 106) filter the whole blood sample and inject the plasma into the injection loop for analysis.

Other methods of separating plasma from other components of blood can also be used to prepare a sample for injection into the system.

### Computer Control of the System for Automated Column Switching HPLC

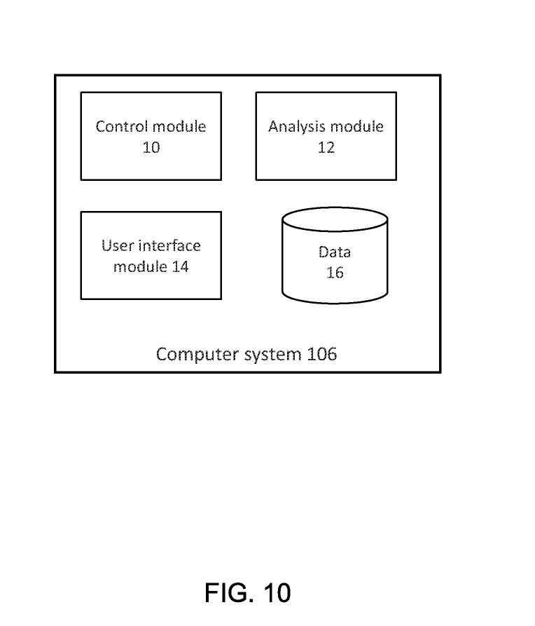

Referring to FIG. 10, the computer system 106 includes a control module 10 that controls the operation of the system 100 and an analysis module 12 that manages, processes, and analyzes data received from the system 100. The computer system 106 also includes a user interface module 14 that can accept control input from a user, e.g., input that specifies parameters for the operation of the system 100. The user interface module 14 can also display data to the user, such as data indicative of a status of the system 100, data collected by the detectors 126, 128, or other data. The computer system 106 can communicate with the system 100 via wired communication (e.g., via a direct wired connection or via a wired network connection) or via wireless communication. In some examples, the computer system 106 is integrated into a single unit with the system 100.

The control module 10 of the computer system 106 controls the operation of the system 100. For instance, the control module can provide signals to turn on or turn off the pumps 124, 134 or to specify the flow rate provided by the pumps 124, 134. The control module 10 can provide signals to actuate the valve 122 to its first position to activate the first flow path 120, or to its second position to activate the second flow path 130. The control module 10 can monitor pressure readings from the pumps 124, 134 to determine whether the pressure in the first or second flow path exceeds a threshold pressure, and if so the control module 10 can actuate the reversing valve 136 to activate the third flow path. The control module 10 can control the fraction collector to collect a specified volume of liquid in each fraction. If an automatic membrane-based filtration is used, the control module 10 can control the application of whole blood into the holder 920 and can control the injection of the plasma into the injection loop 110.

The analysis module 12 of the computer system 106 can provide data management capabilities. For instance, the analysis module 12 can log data received from one or more of the detectors 126, 128. The data can be stored in a data structure 16, such as a database or file structure, in the computer system 106. In some examples, the computer system 106 can automatically generate names for files created to store data. In some examples, the computer system 106 can log data in real time as the data is acquired by the detectors 126, 128. In some examples, the data is stored locally on the detectors 126, 128 during data acquisition and the computer system 106 obtains the data after data acquisition is complete.

The analysis module 12 can also provide data processing capabilities, such as signal averaging to minimize noise in the data. Other data processing operations can also be performed. These data processing operations can be performed automatically or in response to a command by a user of the computer system 106. The analysis module 12 can also provide data analysis capabilities, such as the integration of a chromatograph. Other data analysis operations can also be performed.

The analysis module 12 can make raw or processed data available to a user, e.g., by plotting or otherwise displaying the data in a user interface or by exporting the data to a common format for use in other data analysis and/or visualization programs.

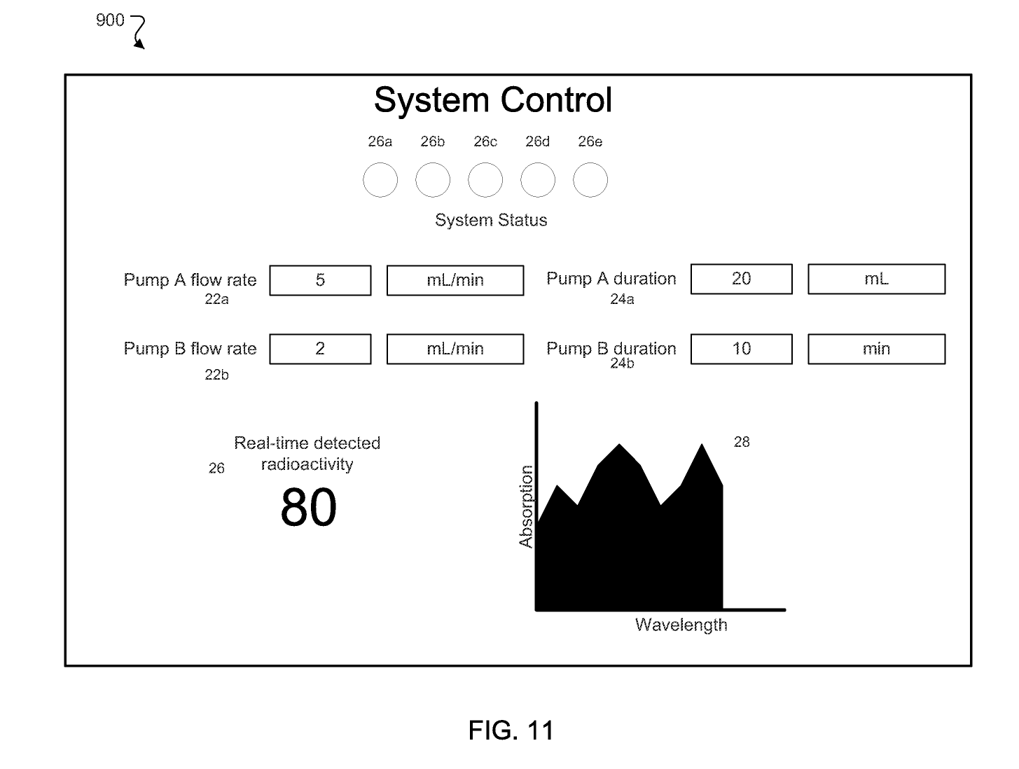

FIGS. 10 and 11 show one example of a user interface module 14 that provides a user interface 20 through which a user of the computer system 106 can specify parameters for the operation of the system 100. For instance, in user interface 20, a user can specify a desired flow rate 22a, 22b for each of the pumps 124, 134, respectively. The user can also specify a flow volume or a flow time 24a, 24b for the flow through each of the first and second flow paths, respectively. Given any two of the three parameters flow rate, flow volume, and flow time, the analysis module 10 can calculate the third parameter. For instance, if the user specifies a flow rate and a flow volume for the first flow path, the analysis module 10 can calculate the time for which the first flow path is to be active. The user interface 20 also allows a user to specify the volume to be collected in each fraction by the fraction collector 138. Other operational parameters can also be provided for user control on the user interface 20, such as parameters related to the filtration of a whole blood sample, the injection of a sample into the injection loop, the threshold pressure for activation of the reversing valve 136, the time for which the third (reversed) flow path is to be active, parameters related to the operation of the detectors 126, 128, and other operational parameters.

The user interface 20 can also display a status of the system, e.g., via a set of status indicator images 26 that indicate whether the system is idle (image 26a), running the first flow path (image 26b), running the second flow path (image 26c), running the third reversed flow path (image 26d), or in a fault status (image 26e). In some examples, the pressure readings from one or both of the pumps 124, 134 can also be displayed on the user interface. Other status indicators can also be displayed on the user interface.

In some examples, the user interface 20 can also display data collected from the detectors 126, 128. For instance, a radioactivity display 28 can indicate the level of radioactivity detected in real time by the radioactivity detector 126. A plot 30 can display spectrometry data collected by a UV-visible spectrometer 128. Other data can also be displayed on the user interface.

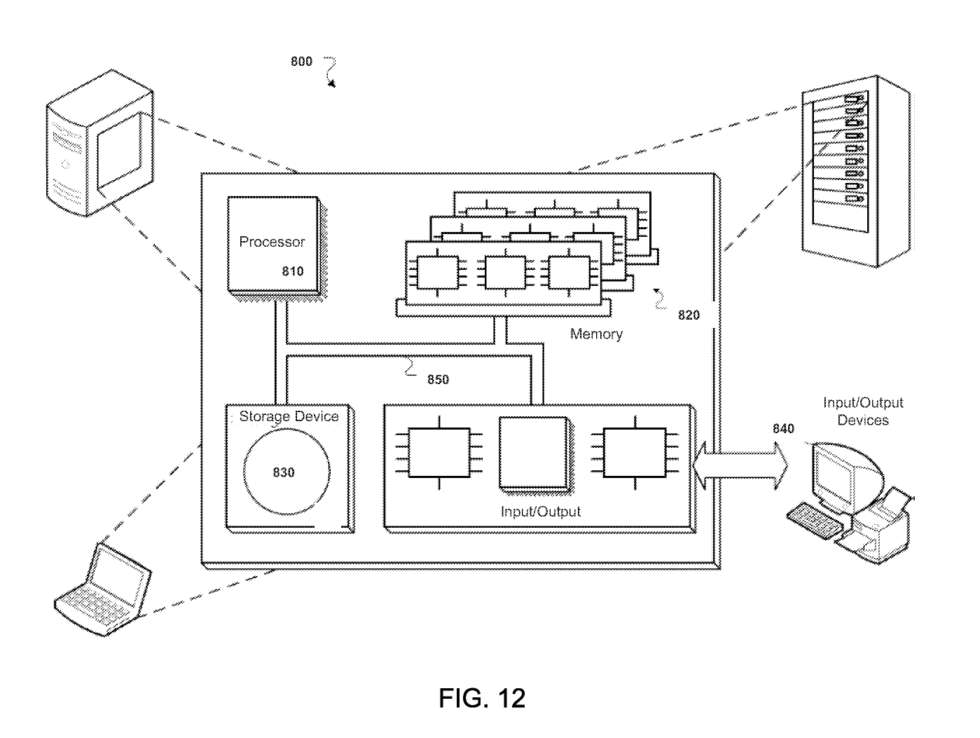

FIG. 12 is a schematic diagram of an example of a computer system 800 that can be used to control the operations described in association with any of the computer-implemented methods described herein, according to one implementation. The system 800 includes a processor 810, a memory 820, a storage device 830, and an input/output device 840. Each of the components 810, 820, 830, and 840 are interconnected using a system bus 850. The processor 810 is capable of processing instructions for execution within the system 800. In one implementation, the processor 810 is a single-threaded processor. In another implementation, the processor 810 is a multi-threaded processor. The processor 810 is capable of processing instructions stored in the memory 820 or on the storage device 830 to display graphical information for a user interface on the input/output device 840.

The memory 820 stores information within the system 800. In some implementations, the memory 820 is a computer-readable medium. The memory 820 can include volatile memory and/or non-volatile memory.

The storage device 830 is capable of providing mass storage for the system 800. In general, the storage device 830 can include any non-transitory tangible media configured to store computer readable instructions. In one implementation, the storage device 830 is a computer-readable medium. In various different implementations, the storage device 830 may be a floppy disk device, a hard disk device, an optical disk device, or a tape device.

The input/output device 840 provides input/output operations for the system 800. In some implementations, the input/output device 840 includes a keyboard and/or pointing device. In some implementations, the input/output device 840 includes a display unit for displaying graphical user interfaces.

The features described herein can be implemented in digital electronic circuitry, or in computer hardware, firmware, or in combinations of them. The features described herein can be implemented in a computer program product tangibly embodied in an information carrier, e.g., in a machine-readable storage device, for execution by a programmable processor; and features can be performed by a programmable processor executing a program of instructions to perform functions of the described implementations by operating on input data and generating output. The described features can be implemented in one or more computer programs that are executable on a programmable system including at least one programmable processor coupled to receive data and instructions from, and to transmit data and instructions to, a data storage system, at least one input device, and at least one output device. A computer program includes a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Various software architectures can be used for implementing the methods and systems described in this application. For example, a publish/subscribe messaging pattern can be used in implementing the methods and systems described herein. In the case of publish/subscribe messaging, the system includes several hardware and software modules that communicate only via a messaging module. Each module can be configured to perform a specific function. For example, the system can include one or more of a hardware module, a camera module, and a focus module. The hardware module can send commands to the imaging hardware implementing the fast auto-focus, which in turn triggers a camera to acquire images.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Computers include a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features described herein can be implemented on a computer having a display device such as a CRT (cathode ray tube) or LCD (liquid crystal display) monitor for displaying information to the user and a keyboard and a pointing device such as a mouse or a trackball by which the user can provide input to the computer. Alternatively, the computer can have no keyboard, mouse, or monitor attached and can be controlled remotely by another computer

The features described herein can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer systems can include clients and servers. A client and server are generally remote from each other and typically interact through a network, such as the described one. The relationship of client and server arises by virtue of computer programs running on the respective computers and having a client-server relationship to each other.

The processor 810 carries out instructions related to a computer program. The processor 810 can include hardware such as logic gates, adders, multipliers and counters. The processor 810 can further include a separate arithmetic logic unit (ALU) that performs arithmetic and logical operations.

### Other Embodiments

It is to be understood that while the invention has been described in conjunction with the detailed description thereof, the foregoing description is intended to illustrate and not limit the scope of the invention, which is defined by the scope of the appended claims. Other aspects, advantages, and modifications are within the scope of the following claims.

1. A method for performing high performance liquid chromatography (HPLC) on a liquid sample, the method comprising:
automatically, using a computer, controlling a liquid sample including a plurality of components to flow through a first flow path in a system for HPLC, wherein flowing through the first flow path includes flowing the liquid sample through a capture column, wherein the capture column is capable of trapping at least some of the components of the liquid sample;
automatically, using the computer, controlling a solvent to flow through a second flow path in the system for HPLC, wherein flowing through the second flow path includes:
flowing the solvent through the capture column to elute at least some of the trapped components from the capture column;
flowing the solvent and eluted components through an analysis column capable of separating at least some of the eluted components; and
flowing the separated components to a detector capable of detecting a property of the separated components.

2. The method of claim 1, wherein automatically controlling the liquid to flow through the first flow path includes controlling the liquid to flow from an injection port, through a valve configured in a first configuration, and through the capture column, and
wherein the method includes actuating the valve to the first configuration based on a signal from the computer.

3. (canceled)

4. The method of claim 2, wherein automatically controlling the solvent to flow through the second flow path includes controlling the solvent to flow through the capture column, through the valve configured in a second configuration, and through the analysis column, and
wherein the method includes actuating the valve to the second configuration based on a signal from the computer.

5.-8. (canceled)

9. The method of claim 1, wherein automatically controlling the solvent to flow through the second flow path includes controlling a second pump to provide a flow of solvent.

10.-12. (canceled)

13. The method of claim 1, further comprising, if a fluid pressure in the second flow path is greater than a threshold pressure, controlling the solvent to flow through a third flow path in the system, and
wherein flowing through the second flow path includes flowing through the analysis column in a first direction and flowing through the third flow path includes flowing through the analysis column in a second direction opposite to the first direction.

14. (canceled)

15. The method of claim 1, wherein flowing through the first flow path includes flowing through the capture column in a first direction and flowing through the second flow path includes flowing through the capture column in a second direction opposite to the first direction.

16. The method of claim 1, further comprising receiving a blood sample; and filtering the blood sample to separate plasma, wherein the liquid is the plasma.

17. (canceled)

18. The method of claim 16, wherein filtering the blood sample includes automatically controlling the filtering of the blood sample using the computer.

19. The method of claim 1, wherein the detector is configured to detect a radioactivity of the separated components.

20. (canceled)

21. The method of claim 1, wherein the liquid includes blood plasma.

22. A system for high performance liquid chromatography (HPLC), the system comprising:
an injection port for receiving a liquid sample including a plurality of components;
a capture column capable of trapping at least some of the components of the liquid sample;
an analysis column capable of separating at least some of the components of the liquid sample;
a detector for detecting a property of the components; and
a computer configured to:
automatically control the liquid sample to flow through a first flow path in the system, wherein flowing through the first flow path includes flowing the liquid sample through the capture column, wherein at least some of the components of the liquid sample are trapped by the capture column;
automatically control a solvent to flow through a second flow path in the system, wherein flowing through the second flow path includes flowing the solvent through the capture column to elute at least some of the trapped components from the capture column, flowing the solvent and eluted components through the analysis column, and flowing the components separated by the analysis column to the detector.

23. The system of claim 22, further comprising a valve, and
wherein the computer is configured to actuate the valve to a first configuration to control the liquid to flow through the first flow path and to actuate the valve to a second configuration to control the liquid to flow through the second flow path.

24.-26. (canceled)

27. The system of claim 22, wherein the computer is configured to, if a fluid pressure in the second flow path is greater than a threshold pressure, automatically control the solvent to flow through a third flow path in the system, and
wherein flowing through the second flow path includes flowing through the analysis column in a first direction and flowing through the third flow path includes flowing through the analysis column in a second direction opposite to the first direction.

28. (canceled)

29. The system of claim 22, further comprising a filter device capable of separating plasma from a blood sample, and wherein the liquid is the plasma.

30. (canceled)

31. The system of claim 29, wherein the computer is configured to control the filter device.

32. The system of claim 22, wherein the detector includes a radioactivity detector.

33. The system of claim 22, further comprising a fraction collector configured to fractionate the components separated by the analysis column.

34. A computer-readable storage medium storing instructions for causing a computer system to:
control a liquid including a plurality of components to flow through a first flow path in a system for HPLC, wherein flowing through the first flow path includes flowing through a capture column, the capture column capable of trapping at least some of the components of the liquid;
control a solvent to flow through a second flow path in the system for HPLC, wherein flowing through the second flow path includes:
flowing through the capture column to elute at least some of the trapped components from the capture column;
flowing through an analysis column capable of separating at least some of the eluted components; and
flowing the separated components to a detector capable of detecting a property of the separated components.

35. The computer readable storage medium of claim 34, wherein controlling the liquid to flow through the first flow path includes controlling the liquid to flow from an injection port, through a valve configured in a first configuration, and through the capture column, and
wherein the computer readable storage medium stores instructions for actuating the valve to the first configuration.

36. (canceled)

37. The computer readable storage medium of claim 35, wherein controlling the solvent to flow through the second flow path includes controlling the solvent to flow through the capture column, through the valve configured in a second configuration, and through the analysis column, and
wherein the computer readable storage medium stores instructions for actuating the valve to the second configuration.

38.-44. (canceled)

45. The computer readable storage medium of claim 34, further storing instructions for causing the computer system to:
receive a signal from the second pump indicative of a fluid pressure in the second flow path; and
if the fluid pressure is greater than a threshold pressure, controlling the solvent to flow through a third flow path in the system,
wherein flowing through the second flow path includes flowing through the analysis column in a first direction and flowing through the third flow path includes flowing through the analysis column in a second direction opposite to the first direction.

46. (canceled)

47. The computer readable storage medium of claim 34, further storing instructions for causing the computer system to control the operation of a filter capable of filtering a blood sample to separate plasma, wherein the liquid is the plasma.

48. (canceled)

49. The computer readable storage medium of claim 34, further storing instructions for causing the computer system to control operation of a fraction separator configured to fractionate the components separated by the analysis column.
